(19) United States
(12) Patent Application Publication
(10) Pub. No.: US 2009/0128362 A1
(43) Pub. Date: May 21, 2009

(54) METHOD AND SYSTEM FOR PROVIDING INFORMATION TO A TRANSPORTATION VEHICLE ON THE PRESENCE OF PASSENGERS

(76) Inventors: Kareem Darwish, Cairo (EG); Ossama Emam, Mohandessen (EG)

Correspondence Address: HOFFMAN WARNICK LLC, 75 STATE ST, 14 FL, ALBANY, NY, 12207, US

(21) Appl. No.: 12/305,479

(22) PCT Filed: May 3, 2007
(86) PCT No.: PCT/EP2007/054300

§ 371 Date: Dec. 18, 2008

(30) Foreign Application Priority Data
Jun. 22, 2006 (EP) 06115910.9

(51) Int. Cl. G08G 1/09

(52) U.S. Cl. 340/901

(57) ABSTRACT

The present invention discloses a method, system and computer program for providing information to transportation vehicles on the presence of passengers who want to travel to a particular destination. The method in each communication system at stops, comprises the steps of:
receiving a request from a passenger to board a vehicle at the stop for a particular destination;
identifying an approaching vehicle going to said particular destination and which would stop at the stop;
forwarding said request to board to the identified vehicle;
receiving a confirmation from the vehicle informing that said vehicle will stop at the stop to board the passenger;
forwarding to the passenger the confirmation received from the vehicle in response to the request to board.
   The method in each vehicle comprises the steps of:
receiving one or a plurality of requests to board, each request to board corresponding to a request of a passenger to board the vehicle at a specified stop to go to a particular destination;
   for each request to board:
sending back a confirmation either that the vehicle will stop at the stop specified in the request or that the vehicle will not stop at the stop specified in the request;
   for each stop:
determining whether or not a confirmation to stop has been sent back;
if no confirmation to stop has been sent back, determining an optimized route to the next stop where at least a confirmation to stop has already been sent back.

### TECHNICAL FIELD OF THE INVENTION

The present invention relates generally to passengers transportation management systems and, more specifically to a system, method and computer program for providing information to a transportation vehicle on the presence of passengers who want to board.

### BACKGROUND OF THE INVENTION

Most people living in cities use city buses as daily transportation vehicles. Regular city buses commonly run in a particular bus line in which bus stops are set at different distances where passengers await the bus. Some buses have official schedule to stop at particular bus stops. Others have no official times to stop at particular stops and may or may not stop depending on the presence of passengers.

An efficient passengers transportation management system is needed to:
minimize the waiting time of passengers at bus stops;
make sure that the passenger is waiting at the right bus stop for a particular bus line;
the bus will not pass by a person waiting at or near a bus stop without picking him/her;
confirm the presence of a passenger at a given bus stop.

During inclement weather, there are situations where passengers huddle in out-of-sight doorways, or where passengers are standing in a position that wrongly indicates to the driver that they are not a passenger. In these particular situations a bus may miss a person waiting at or near a marked bus stop. Transit districts are searching for simple, inexpensive solutions to solve this problem.

Some transportation vehicles have no official times to stop at particular stops and may or may not stop depending on the presence of passengers. In some cases, the transportation vehicles may need to make detours to check on stops at which they may not find passengers (especially at off peak hours) causing delays for passengers who are waiting at other stops and make longer ride times. Another potential scenario is that the vehicle may stop at a stop due to the presence of potential passengers only to find out that they were either seeking a shelter or are waiting for a vehicle that covers a different route. Examples of such vehicles are the circuit buses at large airports and independently owned and operated transportation vehicles often available in large metropolitan areas that traverse certain routes.

The current state of the art is based on three different components:

### 1. Signalling Device

A passenger can alert an incoming transportation vehicle with a signalling device. This signalling device can be used for signalling the bus drivers at a bus stop that a passenger desires to board the bus. The device can also be used for signalling other public transportation vehicles, such as taxis. Such a signalling device is particularly useful when the whether is bad and when passengers huddle in out-of-sight doorways, or when passengers are standing in a position that wrongly indicates to the driver that they are not a passenger.

U.S. Pat. No. 6,355,989 entitled “Public Transportation Signalling Device” discloses a device for signalling the drivers of public transportation vehicles that a passenger wishes to be picked up. The problem with the existing technology is the following:
(a) the passenger may not be able to ascertain the route that the bus will follow. Consequently, he may signal the vehicle to stop erroneously, and
(b) the bus has to follow the complete route and cannot make any detour to save time.

### 2. Notification System

Potential passengers can be informed of the location and arrival time of a desired transportation vehicle by means of a notification system. A large number of patents address this passenger notification issue.

U.S. Pat. No. 5,774,072 entitled “Bus stop signalling system with two way communication” discloses a system and method for a bus to send a signal to the bus stop to indicate that it will stop. The bus stop subsequently informs all persons who are present at the stop using an audio or visual signal.

U.S. Pat. No. 5,483,454 entitled “Portable appliances for informing bus users” discloses a system and method for a portable device that informs the potential passengers of waiting times for a bus.

Similarly, in U.S. Pat. No. 6,177,889 entitled “Method of controlling at least one transit stop display”, passengers are informed of waiting times using a transit stop display.

In U.S. Pat. Nos. 6,904,359, 6,804,606, 6,763,300, and 6,763,299 a user can be informed in advance of the location and estimated time of arrival of vehicles.

In all these systems, the passenger is informed of the location, arrival time and destination of the transportation vehicle. However, all these systems have the following shortcomings:
(a) the transportation vehicle operator does not know whether or not there is a passenger and whether he/she is interested in boarding the vehicle.
(b) these solutions provide no estimate of the expected arrival time to the final destination of the passengers.

### 3. Call System.

The passenger calls a central office and transmits information to an operator who subsequently dispatches a taxi or the passenger. U.S. Pat. No. 6,014,430 entitled “Message System” discloses a device for dispatching messages to order taxis. However, such a system requires a centralized call center and a special dispatch and is not applicable to public transportation. Unlike taxis, generally, a transportation vehicle runs on a specific route and can pick up passengers only along its path.

All the previous solutions suffer from one or more of the following drawbacks:
the passenger is not able to ascertain the route that the bus will follow until it is too close to the bus stop and consequently he may request the vehicle to stop erroneously,
the bus has to follow the complete route and cannot make any detour to save time,
the transportation vehicle operator does not know whether or not there is a passenger waiting for the bus and whether he/she is interested in boarding the bus,
no estimate of the expected arrival time to the final destination is provided,
the proposed solutions are not applicable to public transportation.

There is also a situation that none of the above mentioned solutions covers. This situation is when a passenger is close to more than one bus stop and when different busses can take the passenger to the required destination.

### OBJECTS OF THE INVENTION

It is an object of the present invention to provide information to a transportation vehicle on the presence of a passenger who wants to board the vehicle.

It is another object of the present invention to provide a mechanism for passengers to request a particular transportation vehicle and to receive confirmation.

It is a further object to provide a communication mechanism between a passenger and available transportation vehicles.

### SUMMARY OF THE INVENTION

The present invention is directed to methods, systems and computer programs as defined in independent claims.

The present invention relates generally to passengers transportation management systems and, more specifically to a system, method and computer program for providing information to a transportation vehicle on the presence of passengers who want to board this vehicle. The present invention also provides a communication mechanism between a passenger and available transportation vehicles of potential interest to the passenger. Passengers can communicate with transportation vehicles via centralized or decentralized communication systems that could be located in bus stops for example. Passenger can gather information about available transportation vehicles to particular destinations (and the estimated time to these destinations) and can inform the vehicle operator of his/her intentions.

The method in a communication system associated with a stop. comprises the steps of:
receiving a request from a passenger to board a vehicle at the stop for a particular destination;
identifying an approaching vehicle going to said particular destination and which would stop at the stop;
forwarding said request to board to the identified vehicle;
receiving a confirmation from the vehicle informing that said vehicle will stop at the stop to board the passenger;
forwarding to the passenger the confirmation received from the vehicle in response to the request to board.

The method in a vehicle comprises the steps of:
receiving one or a plurality of requests to board, each request to board corresponding to a request of a passenger to board the vehicle at a specified stop to go to a particular destination;

for each request to board:
sending back a confirmation either that the vehicle will stop at the stop specified in the request or that the vehicle will not stop at the stop specified in the request;

for each stop:
determining whether or not a confirmation to stop has been sent back;
if no confirmation to stop has been sent back, determining an optimized route to the next stop where at least a confirmation to stop has already been sent back.

Further embodiments of the invention are provided in the appended dependent claims.

The foregoing, together with other objects, features, and advantages of this invention can be better appreciated with reference to the following specification, claims and drawings.

### BRIEF DESCRIPTION OF THE DRAWINGS

The novel and inventive features believed characteristics of the invention are set forth in the appended claims. The invention itself, however, as well as a preferred mode of use, further objects and advantages thereof, will best be understood by reference to the following detailed description of an illustrative detailed embodiment when read in conjunction with the accompanying drawings, wherein

FIG. 1 is a general view of the present invention.

FIG. 2 is a flow chart showing the communication system acting as a broker according to the present invention.

FIG. 3 is a flow chart showing the communication system acting as an information repository according to the present invention.

FIG. 4 show flow chart showing the communication system acting as a relay according to the present invention.

FIG. 5 shows the application of the invention on a circuit bus route similar to the routes connecting airport terminals.

FIG. 6 shows another application for the invention.

### PREFERRED EMBODIMENT OF THE INVENTION

The following description is presented to enable one or ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### General Principles

The present invention relates to a system, method and computer program for providing information to a transportation vehicle on the presence of passengers who want to board the vehicle. The present invention also provides a mechanism for passengers to request to ride a particular transportation vehicle and to receive confirmation. The invention addresses the problem of determining whether or not a passenger is present at a bus stop without the need for a transportation vehicle to stop. The present invention gives the passengers the ability to request a transportation vehicle to stop at a particular stop with confirmation from this vehicle. The invention also provides a communication mechanism between a passenger and available transportation vehicles. The passenger can communicate with transportation vehicles via centralized or decentralized communication systems that could be located in bus stops for example to gather information about available transportation vehicles to a particular destination (and estimated time to destination) and to inform the vehicle operator of his/her intention to board a vehicle.

### Main Components

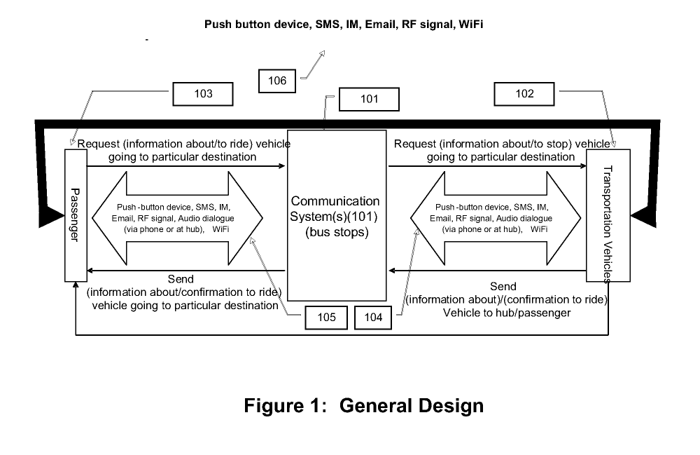

FIG. 1 shows the main components of the invention. A communication system 101 is located in the participating bus stops. This communication system preferably comprises communication and computational means. The communication system 101 operates according to one of the following ways:
The communication system 101 is a broker that receives a request from a passenger 103:
   to obtain information about one or a plurality of vehicles 102, or
   to signal a vehicle 102 to stop.
The communication system 101 forwards the passenger request to the vehicles 102. The communication system receives responses from the vehicles 102 and communicates the received information to the passenger 103.
The communication system 101 is a repository which continuously receives from nearby vehicles 102 information about their location and path. A passenger 103 can request information from the communication system 101. After obtaining the information, the passenger 103 can:
   request from the communication system 101 a confirmation to ride a vehicle 102 (at which point the communication system 101 would act like a broker for confirmation) or
   contact a vehicle 102 directly.
The communication system 101 acts like a relay for the passenger 103 only. The communication system 101 receives from a passenger 103 a request to obtain information or confirmation, and the communication system 101 forwards the request to nearby vehicles 102. The vehicle will then directly communicate with the passenger 103.

The communications 104 between the communication system 101 and the vehicles 102 can be based on the following wireless technologies
RF (Radio Frequency) channel,
WiFi network,
mobile network, . . . .

The communication means may include any appropriate messaging mechanism such as instant messages, RF (Radio Frequency) signals, SMS's (Short Message Services), audio signals (with tones or interactive audio query system with driver of vehicle), etc. The communication means 105 and 106 between passengers 103 and communication systems 101 or vehicles 102 respectively are similar to the communication means 104 between the communication systems 101 and vehicles 102.

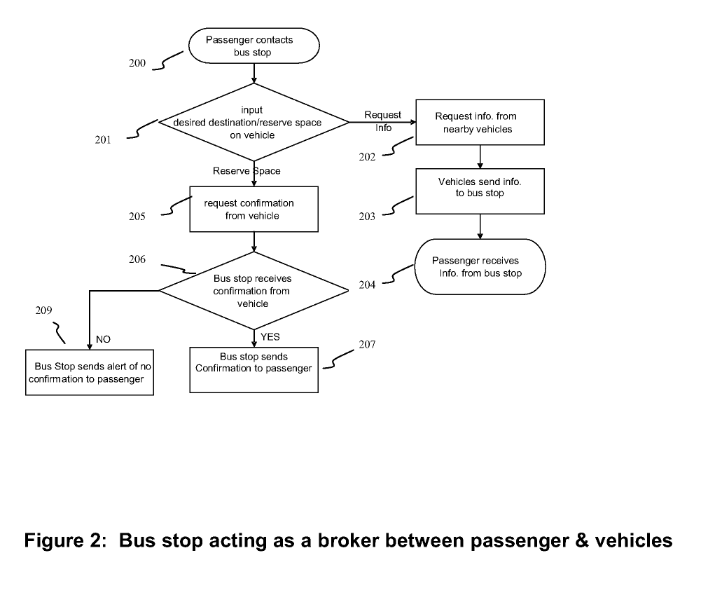

FIGS. 2, 3, and 4 show how the communication system 101 can act namely as a broker, an information repository, or a relay respectively.

### Communication System Acting as a Broker

As shown in FIG. 2, when the communication system acts as a broker, the method according to the present invention comprises the following steps:
Step 200—The passenger contacts the communication system associated with the bus stop) with a request for information about vehicles going to a particular destination.
Step 201—The communication system associated with the bus stop receives the request sent by the passenger and checks whether or not vehicles going to the passenger's destination would stop at the bus stop.
Step 202—If the passenger wants to know the status of approaching vehicles going to the desired destination, the communication system forwards this request to nearby transportation vehicles.
Step 203—The transportation vehicles receive the request forwarded by the communication system and send back a response to the communication system. The response may include information such as the distance to bus stop, the expected arrival time to bus stop, the number of available seats, and the arrival time to destination.
Step 204—The communication system associated with the bus stop forwards the information received from the transportation vehicles going to the destination to the passenger originator of the request.
Step 205—In view of the received information, if the passenger wants to reserve a seat in a vehicle of his/her choice, he/she will send a request for a reservation to the communication system. The communication system in its turn will forward the passenger's request to this particular vehicle.
Step 206—The communication system waits for a confirmation from the vehicle and upon reception of this confirmation, checks whether this confirmation is positive (a seat can be reserved for the passenger in the vehicle) or negative (a seat cannot be reserved for the passenger in the vehicle).
Step 207—If the communication system of the bus stop receives a positive confirmation from the vehicle concerning the reservation of a seat for the passenger, the communication system will confirm the reservation to the passenger originator of the request.
Step 208—If the communication system of the bus stop receives a negative confirmation from the vehicle or no confirmation at all, the communication system will reply by a “no confirmation” alert to the passenger originator of the request.

### Communication System Acting as a Repository

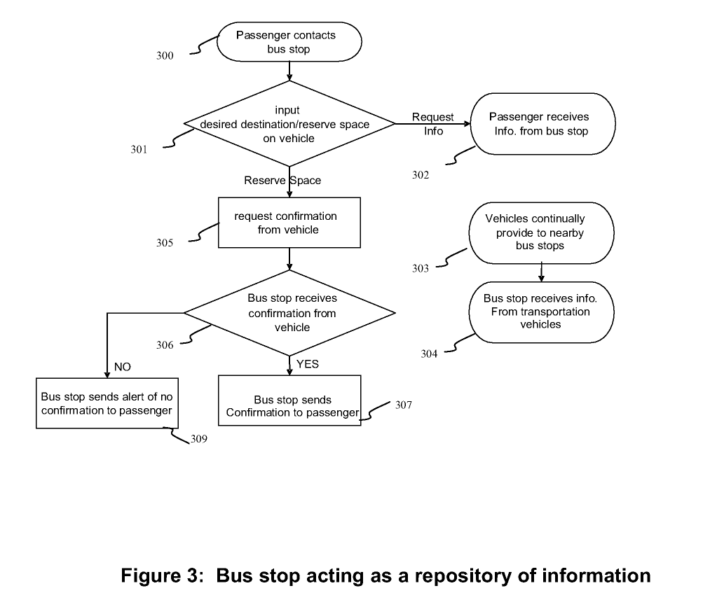

As shown FIG. 3, when the communication system acts as a repository, the method according to the present invention comprises the following steps:
Step 300—The passenger contacts the communication system associated with the bus stop with a request for information about vehicles going to a particular destination.
Step 301—The bus stop receives the request sent by the passenger and checks whether or not vehicles going to the passenger's destination would stop at the bus stop.
Step 302—If the passenger wants to know the status of approaching vehicles going to the desired destination, the communication system retrieves the requested information from a repository and sends back the retrieved information to the passenger originator of the request.
Step 305—In view of the received information, if the passenger wants to reserve a seat on a vehicle of his/her choice, he/she will send a request for a reservation to the communication system of the bus stop. The communication system in its turn will forward the passenger's request to this particular vehicle.
Step 306—The communication system of the bus stop waits for a confirmation from the vehicle and upon reception of this confirmation, checks whether this confirmation is positive (a seat can be reserved for the passenger in the vehicle) or negative (a seat cannot be reserved for the passenger in the vehicle).
Step 307—If the communication system of the bus stop receives a positive confirmation from the vehicle concerning the reservation of the seat for the passenger, the communication system confirms the reservation to the passenger originator of the request.
Step 308—If the communication system of the bus stop receives a negative confirmation from the vehicle or no confirmation at all, the communication system replies by a “no confirmation” alert to the passenger originator of the request.

When the communication system at the bus stop acts as a repository, the following two steps are continuously executed:
Step 303: Transportation vehicles continuously provide information to nearby bus stops. This information comprises for instance the distance to the bus stop, the expected arrival time to the bus stop, the number of available seats, and the arrival time to destination.
Step 304: Communication systems at bus stops continuously receive the information sent by the transportation vehicles.

### Communication System Acting as a Relay

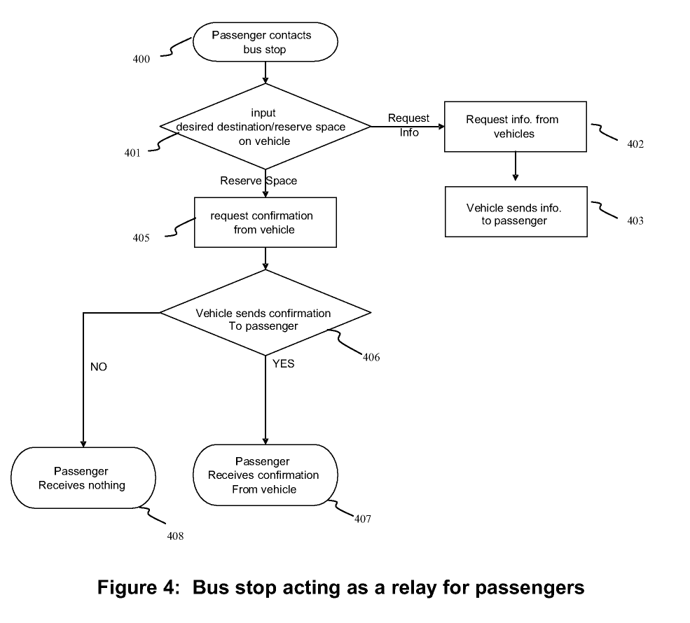

As shown in FIG. 4, when the communication system acts as a relay, the method according the present invention comprises the following steps:
Step 400—The passenger contacts the communication system associated with the bus stop with a request for information about vehicles going to a particular destination.
Step 401—The communication system at the bus stop receives the request sent by the passenger and checks whether or not vehicles going to the passenger's destination would stop at the bus stop.
Step 402—If the passenger wants to know the status of approaching vehicles going to the desired destination, the bus stop forwards the request to nearby transportation vehicles.
Step 403—The transportation vehicles receive the information forwarded by the bus stop and send back a response to the passenger. The response may include information such as the distance to bus stop, the expected arrival time to bus stop, the number of available seats, and the arrival time to destination.
Step 405—In view of the received information, if the passenger wants to reserve a seat in a vehicle of his/her choice, the passenger will send a request for a reservation to the communication system of the bus stop. The communication system will in its turn forward the passenger's request to this particular vehicle. Alternatively, the passenger can send a reservation request directly to the vehicle.
Step 406—The passenger waits for a confirmation from the vehicle and upon reception of this confirmation, checks whether this confirmation is positive (a seat can be reserved for the passenger in the vehicle) or negative (a seat cannot be reserved for the passenger in the vehicle).
Step 407—The passenger receives a positive confirmation of the reservation from the vehicle.
Step 408—The passenger receives a negative confirmation from the vehicle or no confirmation at all.

### Particular Applications

### Circuit Connecting Airport Terminals

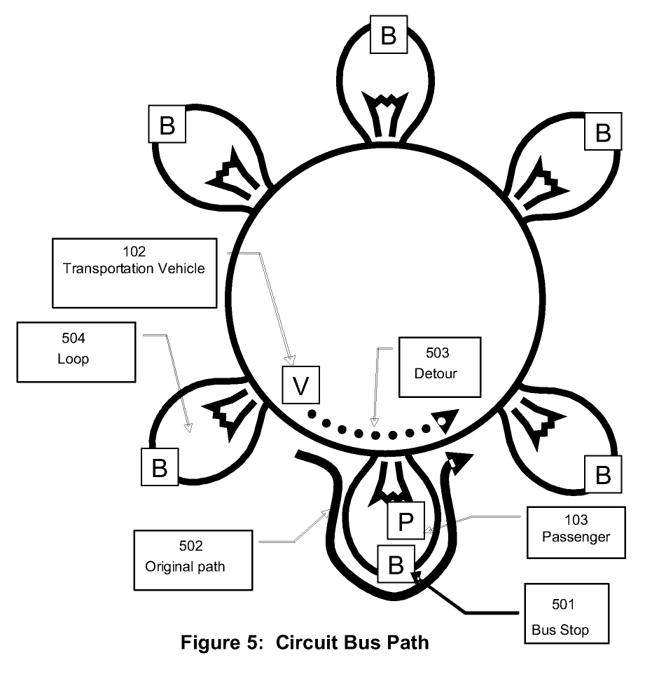

FIG. 5 shows a particular application of the invention on a circuit such as a circuit connecting airport terminals. The vehicle V 102 traverses the path of the route to pickup passengers P 103. Typically, the vehicle V 102 follows the original path 502 at every loop to check whether or not there are passengers 103 waiting at the bus stops B 501. Most of the time, there are no passengers 103 waiting at the bus stop 501. If the vehicle knew that, then the vehicle 102 could alternatively take a detour 503 rather than the original path 502 for the loop 504.

### Multiple Bus Stops

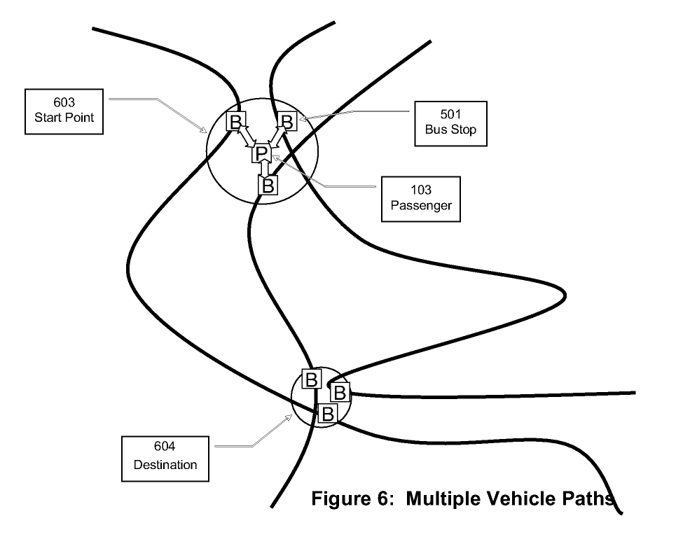

FIG. 6 shows another application of the invention in which a passenger 103 is close to more than one bus stop 501. At each of these bus stops, vehicles 102 can take the passenger 103 to his/her destination 604. The passenger 103 sends a request to the communication system 101 (which can be at the bus stop 501) and the communication system behaves according to one of the ways described earlier (as a broker, an information repository, or a relay).

The communication system sends either to a centralized system or to transportation vehicles within a certain distance of the stop, a communication signal indicating the presence of a passenger interested in boarding a vehicle following a particular route or going to a particular destination.

The communication system sends the signal at the request of a passenger. The passenger may use a push-button device at the bus stop, an audio system (a voice processing system), a wireless system (a cell phone for example), or any other communication means.

Upon reception of the signal, each available transportation vehicle replies indirectly to the passenger via the communication system or directly to the passenger (by means of an audio, visual, electronic, or some other kind of communication signal), with a signal indicating that it can stop at the requested bus stop. This signal may also comprise other information such as the approximate distance to the bus stop, the approximate arrival time at the bus stop, available seats in the vehicle, the approximate arrival time to destination, etc . . . .

Given the previous scenario, a passenger may also sends signals to multiple communication systems indicating his/her desire to board a transportation vehicle that would follow a particular route or reach a particular destination. The bus stops:
if they act as broker, send a signal to search for available vehicles that could meet the user needs, or
if they act as a repository, may already contain information previously sent to them by the transportation vehicles.

The information may be reported back to the passenger from the communication systems (if they act as either broker or information repository) or directly from the vehicles (if the communication systems act as relay). The passenger can use this information to decide on which bus stop to go to and in which vehicle to board.

### Reservation

When the passenger decides to board a particular vehicle, he/she sends a request to the appropriate communication system or directly to the vehicle indicating his desire (time, destination, . . . ). If the passenger decides to communicate his/her desire to the communication system, then the communication system informs the transportation vehicle. The choice of the communication system with which the passenger communicates depends on many factors such as the physical proximity of the communication system of the bus stop, the subscription service, or the availability of the transportation vehicles that go to the desired destination and stop at the bus stop corresponding to the communication system. The transportation vehicle may optionally sends either to the communication system (and consequently to the passenger) or directly to the passenger, a confirmation that it will really stop.

While the invention has been particularly shown and described with reference to a preferred embodiment, it will be understood that various changes in form and detail may be made therein without departing from the spirit, and scope of the invention.

1-21. (canceled)

22. A method, in a communication system associated with a vehicle stop, comprising:
receiving a request from a passenger to board a vehicle at the stop for a particular destination;
identifying an approaching vehicle going to the particular destination and which would stop on request at the stop;
forwarding the request to board to the identified vehicle;
receiving a confirmation from the vehicle informing that the vehicle will stop at the stop to board the passenger; and
forwarding to the passenger the confirmation received from the vehicle in response to the request to board.

23. The method according to claim 22, wherein the identified vehicle stops at the stop if there is at least one request to board and does not stop at the stop if there is no request to board.

24. The method according to claim 23, wherein identifying an approaching vehicle going to the particular destination and which would stop at the stop, further comprises:
identifying the approaching vehicle going to the particular destination from information contained in the passenger's request to board.

25. The method according to claim 22, wherein receiving a confirmation from the vehicle informing that the vehicle will stop at the stop to board the passenger, further comprises:
receiving a confirmation from the vehicle informing that a seat is reserved for the passenger in the vehicle.

26. The method according to claim 22, further, comprising:
receiving a request for information from a passenger to go to a particular destination;
identifying one or plurality of approaching vehicles going to the particular destination and which would stop at the stop or to a nearby stop; and
forwarding the passenger's request for information to the identified vehicles.

27. The method according to claim 26, wherein forwarding the passenger's request for information to the identified vehicles, further comprises:
receiving back the requested information from one or a plurality of the identified vehicles; and
forwarding to the passenger the received information in response to the request for information.

28. The method according to claim 27, wherein each requested information received back from an identified vehicle comprises:
a distance between the identified vehicle and the stop;
an arrival time to the stop;
an indication of available seats within the approaching vehicle; and
an arrival time to destination.

29. The method according to claim 22, further comprising:
receiving a request for information from a passenger to go to a particular destination;
identifying one or plurality of approaching vehicles going to the particular destination and which would stop on request at the stop;
retrieving from a local repository information related to the identified vehicles; and
forwarding to the passenger the retrieved information in response to the request for information.

30. The method according claim 29, wherein the retrieved information comprises for an identified vehicle:
a distance between the identified vehicle and the stop;
an arrival time to the stop;
an indication of available seats within the approaching vehicle; and
an arrival time to destination.

31. The method according to claim 29, further comprising:
receiving information from vehicles approaching the stop; and
storing the information in a local repository.

32. A communication system associated with a vehicle stop, comprising:
a system for receiving a request from a passenger to board a vehicle at the stop for a particular destination;
a system for identifying an approaching vehicle going to the particular destination and which would stop on request at the stop;
a system for forwarding the request to board to the identified vehicle;
a system for receiving a confirmation from the vehicle informing that the vehicle will stop at the stop to board the passenger; and
a system for forwarding to the passenger the confirmation received from the vehicle in response to the request to board.

33. A method in a vehicle, comprising:
receiving at least one request to board, each request to board corresponding to a request of a passenger to board the vehicle at a specified stop to go to a particular destination;
for each request to board:
sending back a confirmation either that the vehicle will stop at the stop specified in the request or that the vehicle will not stop at the stop specified in the request;
for each stop:
determining whether or not a confirmation to stop has been sent back; and
if no confirmation to stop has been sent back, determining an optimized route to a next stop where at least a confirmation to stop has already been sent back.

34. The method according to claim 33, wherein each request to board is received from at least one communication system associated with a stop.

35. The method according to claim 34, wherein for each request, the confirmation is sent back to the communication system which sent the request.

36. The method according to claim 33, wherein for each request, the confirmation is directly sent back to the passenger.

37. The method according to claim 33, wherein sending back a confirmation that the vehicle will stop at the stop specified in the request or that the vehicle will not stop at the stop specified in the request, further comprises:
determining whether or not there is a place in the vehicle for the passenger and if there is a place, reserving the place for the passenger.

38. The method according to claim 33, further comprising:
receiving at least one request for information, each request for information corresponding to a request of a passenger at a specified stop to go to a particular destination; and
for each request for information, sending back the requested information.

39. The method according claim 38, wherein the requested information comprises:
a distance between the vehicle and the stop;
an arrival time to the stop;
an indication of available places within the vehicle; and
an arrival time to destination.

40. A system in a vehicle, comprising:
a system for receiving at least one request to board, each request to board corresponding to a request of a passenger to board the vehicle at a specified stop to go to a particular destination;
a system for sending back a confirmation, for each request to board, either that the vehicle will stop at the stop specified in the request or that the vehicle will not stop at the stop specified in the request; and
a system for determining, for each stop, whether or not a confirmation to stop has been sent back; and
a system for determining, if no confirmation to stop has been sent back, an optimized route to a next stop where at least a confirmation to stop has already been sent back.
